(19) United States
(12) Patent Application Publication
(10) Pub. No.: US 2025/0142324 A1
(43) Pub. Date: May 1, 2025

(54) MULTICAST FRAME TRANSMISSION IN WIRELESS LOCAL AREA NETWORK

(71) Applicant: HEWLETT PACKARD ENTERPRISE DEVELOPMENT LP, Spring, TX (US)

(72) Inventors: Jianpo Han, Beijing (CN); Kangchang Huang, Beijing (CN); Qiang Zhou, Sunnyvale, CA (US)

(21) Appl. No.: 18/498,291

(22) Filed: Oct. 31, 2023

(51) Int. Cl. H04W 12/0431; H04W 12/76; H04W 84/12

(52) U.S. Cl. CPC H04W 12/0431; H04W 12/76; H04W 84/12

(57) ABSTRACT

In implementations of the present disclosure, there is provided an approach for transmitting multicast frames. A method comprises obtaining a multicast frame in a wireless local area network (WLAN), where the WLAN includes a plurality of sub-networks with a same service set identifier (SSID). Then, a target sub-network of the plurality of sub-networks for receiving the multicast frame is determined based on the multicast frame and a unique group temporal key (GTK) for the target sub-network is obtained based on the target sub-network. Next, the multicast frame is encrypted using the obtained unique GTK for the target sub-network, and the encrypted multicast frame is transmitted to one or more client devices in the target sub-network. Implementations of the present disclosure can help the AP to reduce leakage of multicast frames to all client device by using the GTK corresponding the target sub-network.

### BACKGROUND

A personal area network (PAN), which is a type of network that provides wireless communication between electronic devices in close proximity, has been rapidly advancing in recent years. This technology has enabled efficient and convenient data transmission between various personal devices, such as smartphones, laptops, and wearable devices. On the other hand, a virtual local area network (VLAN) is a technology that allows multiple devices to be connected to a single local area network (LAN) while providing the functionality of multiple independent LANs.

The need for PAN or VLAN arises from the growing demand for efficient and secure network connectivity. For example, customers such as universities or hospitals need PAN/VLAN features over wired/wireless networks. Meanwhile, they don't want to create too many service set identifiers (SSIDs) on an access point (AP). Customers want to dynamically derive VLAN/PAN identifier (ID) for clients that are connected to the same WLAN SSID, and each VLAN/PAN should be completely isolated from other PANs/VLANs under the same WLAN SSID.

### BRIEF DESCRIPTION OF THE DRAWINGS

Implementations of the present disclosure may be understood from the following Detailed Description when read with the accompanying figures. In accordance with the standard practice in the industry, various features are not drawn to scale. In fact, the dimensions of the various features may be arbitrarily increased or reduced for clarity of discussion. Some examples of the present disclosure are described with respect to the following figures.

FIG. 1 illustrates a block diagram of an example environment in which reference implementations of the present disclosure may be implemented;

FIG. 2 illustrates an example of a plurality of PANs/VLANs under the same WLAN SSID according to implementations of the present disclosure;

FIG. 3 illustrates an example of transmitting a multicast frame according to implementations of the present disclosure;

FIG. 4 illustrates another example of transmitting a multicast frame according to implementations of the present disclosure;

FIG. 5 illustrates an example of transmitting an uplink multicast frame according to implementations of the present disclosure;

FIG. 6 illustrates an example of a segmented multicast data frame according to implementations of the present disclosure;

FIG. 7 illustrates a flow chart of an example method for transmitting a multicast frame according to implementations of the present disclosure; and

FIG. 8 illustrates an example access point according to implementations of the present disclosure.

### DETAILED DESCRIPTION

As discussed above, the user wants to dynamically derive VLAN/PAN IDs for client devices that are connected to the same WLAN SSID and use VLAN/PAN to manage the client device. For example, in PAN project, there will be a plurality of PANs and/or VLANs under the same SSID. But multicast/broadcast frames are encrypted using the same GTK. It means that multicast/broadcast frames destined to different VLANs/PANs are not isolated. This presents a significant security defect in the PAN project.

To forward a multicast frame to a VLAN/PAN, a traditional solution needs to convert a multicast frame to a unicast frame for each client in the same VLAN/PAN, and then send it to those clients separately. However, this method introduces a heavy burden to central processing units (CPUs), memories, and air resources. When an AP has tens/hundreds of connected clients, the multicast to unicast (M2U) will exhaust CPUs, memories, and air resources. If the AP doesn't perform the M2U, the multicast frame will be leaked to all stations.

Therefore, implementations of the present disclosure propose a solution of transmitting a multicast frame to client devices in the target sub-network. According to implementations of the present disclosure, an AP obtains a multicast frame in a wireless local area network (WLAN). The WLAN includes a plurality of sub-networks with a same SSID. The AP may use the multicast frame to determine a target sub-network of the plurality of sub-networks for receiving the multicast frame, and obtain a unique group temporal key (GTK) corresponding to the target sub-network. The plurality of sub-networks with a same SSID may be assigned with a plurality of different GTKs, and each sub-network has a corresponding GTK. Then, the AP uses the obtained unique GTK for the target sub-network to encrypt the multicast frame. The encrypted multicast frame is transmitted to one or more client devices in the target sub-network.

One or more client devices in the target sub-network may receive the encrypted multicast frame and use the corresponding GTK to decrypt the encrypted multicast frame. The client devices in other sub-networks cannot decrypt the encrypted multicast frame because they do not have the unique GTK for the target sub-network. Implementations of the present disclosure may provide a unique group key GTK to each VLAN/PAN group. Therefore, the multicast frame of each VLAN/PAN will be encrypted or decrypted using its own GTK. In this case, the encrypted multicast frame will not be leaked to all client devices connected to the AP.

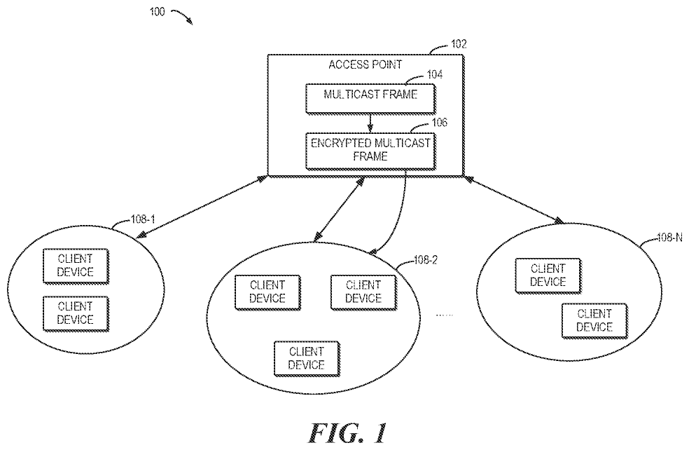

Other advantages of implementations of the present disclosure will be described with reference to the reference implementation as described below. Reference is made below to FIG. 1 through FIG. 8 to illustrate basic principles and several reference implementations of the present disclosure herein.

FIG. 1 shows a block diagram of an example environment in which reference implementations of the present disclosure may be implemented. In the example environment 100 of FIG. 1, an AP 102 communicates with a plurality of sub-networks, including a sub-network 108-1, a sub-network 108-1, . . . , a sub-network 108-N, where N is an integer. Furthermore, the plurality of sub-networks is under the same SSID. Each of the plurality of sub-networks may be a PAN or a VLAN, and includes one or more client devices. For example, the sub-network 108-1 includes two client devices, the sub-network 108-2 includes three client devices, and the sub-network 108-N includes two client devices. The client devices included in the sub-network may be any type of computing device that can join the network, for example, a smartphone, laptops, tablets, smart home appliances, any suitable wearable devices, and so on.

In the implementations of FIG. 1, the plurality of sub-networks may be assigned a plurality of different credentials, for example, the plurality of sub-networks being assigned the multiple pre-shared keys for the AP 102. Each sub-network can be assigned a pre-shared key as a credential for the AP 102. Any client device can use a credential corresponding to a sub-network to join into a sub-network. A credential for one sub-network of the plurality of sub-networks is different from a credential for another sub-network of the plurality of sub-networks.

For example, when a client device joins into the wireless network provided by the AP 102, the client device will transmit the credential to the AP 102. Then, the AP 102 may determine that the client device belongs to which sub-network based on the credential. For example, the AP stores a mapping relationship between a plurality of sub-networks and corresponding credentials. When the AP receives a credential, it will use the credential to search the sub-network from the mapping relationship between a plurality of sub-networks and corresponding credentials. In one example, a client device transmits a credential to the AP 102, and the AP 102 may determine that the credential is used by which sub-network of the plurality of sub-networks. If the credential is the same as the credential for the sub-network 102, the AP 102 will determine that the client device belongs to the sub-network 108-2. In this way, all devices connected to the AP can be divided into a plurality of sub-networks.

The AP 102 may assign a plurality of different GTKs to a plurality of sub-networks under the same WLAN SSID, and each sub-network has a GTK. The AP 102 may transmit multicast frames to different sub-networks by using the plurality of different GTKs. When the AP 102 needs to transmit a multicast frame, the AP 102 first determines the multicast frame will be transmitted to which sub-network. The determined sub-network is used as the target sub-network. Then, the AP 102 finds a unique GTK for the target sub-network. The multicast frame next will be encrypted using the unique GTK for the target sub-network.

For example, the AP 102 will transmit a multicast frame 104 to a sub-network. The AP 102 needs to determine that the multicast frame 104 will be transmitted to which sub-network among the sub-network 108-1, the sub-network 108-2, . . . , and the sub-network 108-N. In this example, the sub-network 108-2 is determined to receive the multicast frame 104. In order to ensure that the multicast frame 104 is only received by the sub-network 108-2, the AP 102 needs to find the GTK for the sub-network 108-2 and encrypt the multicast frame 104 using the unique GTK for the sub-network 108-2 to generate an encrypted multicast frame 106. Then, the encrypted multicast frame 106 is transmitted to the client devices in the sub-network 108-2.

The client devices in the sub-network 108-2 have obtained the GTK for the sub-network 108-2 when they establish connections with the AP 102. Therefore, the client devices in the sub-network 108-2 may decrypt the encrypted multicast frame 106 using the unique GTK for the sub-network 108-2. Because client devices in other sub-networks cannot obtain the unique GTK for the sub-network 108-2, even if they receive the encrypted multicast frame, they cannot decrypt the encrypted multicast frame and cannot obtain the information in the encrypted multicast frame. Therefore, the multicast frame for the sub-network 108-2 will not be leaked to other client devices in other sub-networks. For example, client devices in the sub-network 108-1 and the sub-network 108-N cannot decrypt the encrypted multicast frame and obtain the information in the encrypted multicast frame.

Furthermore, in a traditional solution, when sending a multicast frame, the AP needs to check the power save (PS) status of all client devices connected to the AP. If any one of all client devices connected to the AP is in PS, the AP needs to buffer this multicast frame and send it out either after sending an announcement traffic indication message (ATIM) or when all devices wake up. Therefore, AP has less chance to send the multicast frame out immediately, and latency is longer. In some implementations of the present disclosure, when the AP 102 transmits the multicast frame, it only needs to check the PS status of the client devices in the target sub-network. For example, if the AP 102 transmits the multicast frame to the sub-network 108-2, it only needs to check the PS status of the client devices in the sub-network 108-2. At this time, the number of the client devices that require PS status checks is reduced. Therefore, the AP 102 has more chance to send the multicast frame out immediately, and the latency is lower than the standard way.

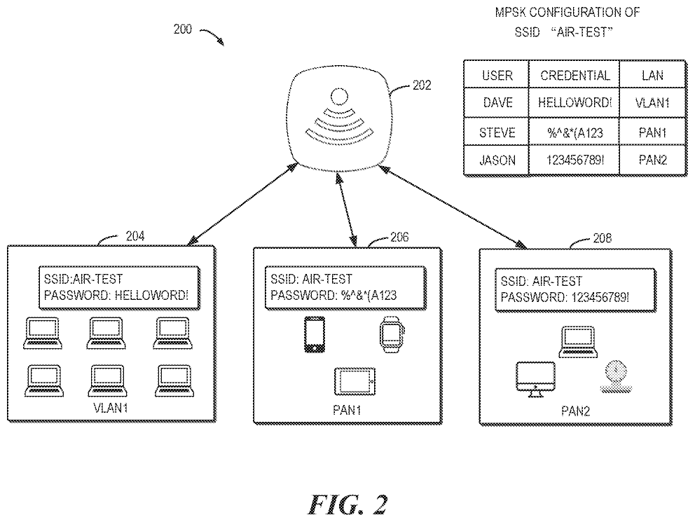

FIG. 2 illustrates an example 200 of a plurality of PANs/VLANs under a same WLAN SSID according to implementations of the present disclosure. In FIG. 2, there is a MPSK configuration of wireless network SSID “AIR-TEST.” In the configuration, there are three LANs under the same SSID, “AIR-TEST,” which are also referred to as three sub-networks. The three LANs include VLAN1, PAN1, and PAN 2. The VLAN1 includes the credential “HELLOWORD!” and the user is DAVE. The PAN1 includes a credential “%\hat{ }&*(A123”, and the user is STEVE. The PAN2 includes a credential “123456789!” and the user is JASON. The credentials for the three LANs are the password for joining in the network provided by AP, and the credentials for the three LANs are different. Therefore, the credentials may be used to determine a LAN that a client device belongs to. As shown in FIG. 2, the client devices connected to AP 202 are divided into three LANs, for example, VLAN1 204, PAN1 206, and PAN 208. In VLAN1, there are many notebook connecting to the AP. In PAN 1 and PAN2, there are some computing devices related to a user, for example, a mobile phone, a pad, or wearable devices, and so on. In FIG. 2, all client devices in all LANs are based on a same SSID.

For example, when a client device for the user “STEVE” needs to be connected to the network provided by the AP, the password “%\hat{ }&*(a123” is used. The password “%\hat{ }&*(a123” will be input into the client device by the user, and the client device transmits it to the AP 102 during the handshake process. Then the AP 202 may determine that the password is the same as the credential of the sub-network-206. Therefore, the client device is assigned to the sub-network 206 based on the password or the credential.

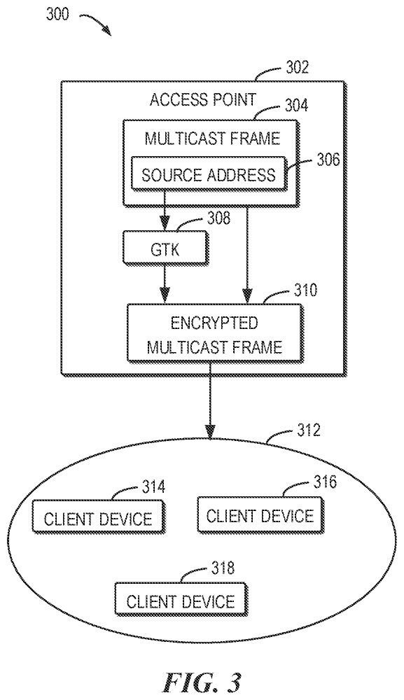

FIG. 3 illustrates an example 300 of transmitting a multicast frame according to implementations of the present disclosure. In FIG. 3, an AP 302 needs to transmit a multicast frame 304 to client devices in the sub-network 312. In one example, the multicast frame 304 is generated by the AP 302. In another example, the multicast frame 304 is obtained from other device and is forward by AP 302. The multicast frame 304 may be an 802.3 frame or an 802.11 frame. Then the AP 302 may obtain the source address 306 in the frame header of the multicast frame 304. The source address 306 may be used to determine a unique GTK 308 corresponding to the sub-network 312. The source address may store the address of the sub-network, which may be used as an ID of a sub-network. Then, the AP 302 uses the ID of the sub-network to look for a unique GTK corresponding to the ID of a sub-network. The AP 102 may finally obtain a unique GTK corresponding to the ID of a sub-network. For example, the AP 302 may obtain a mapping relationship between a plurality of GTKs and a plurality of ID of a plurality of sub-networks. Then, the AP 302 searches for the GTK corresponding to the ID of a sub-network from the mapping relationship.

After obtaining the GTK 308, the AP 302 uses the GTK 308 to encrypt the multicast frame 304 to generate an encrypted multicast frame 310. The AP 302 may use any suitable algorithm to encrypt the multicast frame based on the GTK 308. For example, the algorithm is an advanced encryption standard algorithm. Then, the AP 302 transmits the encrypted multicast frame 310 to the sub-network 312. The sub-network 312 includes a client device 314, a client device 316, and a client device 318. The client devices in the sub-network 312 may receive the encrypted multicast frame 312. The client devices in the sub-network 312 have stored the unique GTK for the sub-network 312. For example, when the client device 314 establishes the connection with the AP 302, the unique GTK for the sub-network 312 can be transmitted to the client device 314 from the AP 312 during the handshake process. The GTK may be obtained by the following equations.

$$GTK = PRF - X ( GMK , ” Group key expansion ” , ap mac \vert Anonce ) , )$$

wherein “PRF-X” represents a pseudorandom function, “GMK” represents a group master key, “Group key expansion” is a string, “ap mac” is an address, and “Anonce” is a nonce.

Therefore, the client devices in the sub-network 312 can decrypt the encrypted multicast frame with the unique GTK for the sub-network 312 and obtain the information in the multicast frame. The client devices in other sub-networks do not have the unique GTK for the sub-network 312. Therefore, the client devices in other sub-networks cannot decrypt the encrypted multicast frame 310. This process avoids leaking the multicast frame to all client devices connected to the AP 302 and ensures that the multicast frame may only be received by the client devices in the sub-network 312.

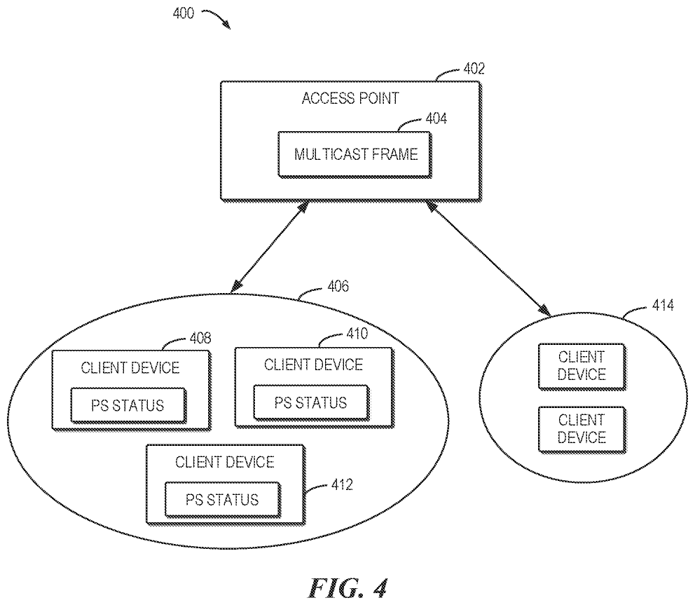

FIG. 4 illustrates another example 400 for transmitting a multicast frame according to implementations of the present disclosure. In FIG. 4, the AP 402 obtains a multicast frame 404. The multicast frame 404 will be transmitted to the sub-network 406 and the multicast frame is not for the sub-network 414. For example, the source address of the multicast frame is the address of the sub-network 406. Unlike the traditional way, when the AP 402 transmits the multicast frame 404 to the sub-network 406, it does not need to check the PS status of all client devices connected to the AP. For example, the AP 402 does not check the PS status of the client devices in the sub-network 406 and the sub-network 414. Because the multicast frame is transmitted to the sub-network 406, the AP 402 only checks the PS status of the client devices in the sub-network 406. For example, the sub-network 406 includes a client device 408, a client device 410, and a client device 412. Therefore, the AP checks the PS status of the client device 408, the client device 410, and the client device 412 and does not check the PS status of client devices of sub-network 414.

During the check process, if any one of the client devices in the sub-network 406 is in the PS, the AP 402 would not transmit the multicast frame 404 to the client devices in the sub-network 406. The AP 402 needs to buffer the multicast frame 404. In one implementation, the AP 402 will first transmit an ATIM to the client devices 408, 410, and 412 in the sub-network 406 to notify the client devices 408, 410, and 412 in the sub-network 406 that there is pending traffic to be transmitted. Then, the AP 402 transmits the multicast frame 404 to the clients in the sub-network 406. In another implementation, the AP 402 waits for all client devices in the sub-network 406 to wake up. When all client devices in the sub-network 406 wake up, the AP 406 transmits the multicast frame to the client devices in the sub-network 406. Therefore, compared with the traditional solution that checks the PS status of all client devices connected to the AP device, this disclosure only checks the PS status of client devices in the sub-network, which gives the AP more chance to send out the multicast frame immediately and the latency is lower than the traditional way.

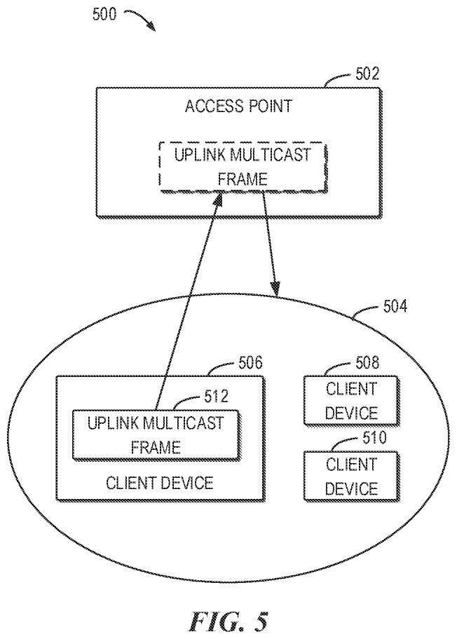

FIG. 5 illustrates an example 500 for transmitting an uplink multicast frame according to implementations of the present disclosure. As shown in FIG. 5, there is a sub-network 504. The sub-network may include a plurality of client devices, for example, a client device 506, a client device 508, and a client device 510. The sub-network is based on the AP 502. One of the client devices in the sub-network 504 may transmit a multicast frame to the client devices in the sub-network 504. For example, the client device 506 transmits a multicast frame to the client device 508 and the client device 510. Because the client devices in the sub-network are based on the AP, when the client device in the sub-network 504 needs to transmit a multicast frame to the client devices in the sub-network 504, the client device needs to transmit an uplink multicast frame 512 to the AP 502. Then, the AP 502 transmits the uplink multicast frame to the client devices in the sub-network 504.

The uplink multicast frame at least includes a receiver address (RA), a transmitter address (TA), and a destination address (DA). The RA may be set as a basic service set identifier (BSSID) for the AP 502, the TA may be set as the address of the client device which transmits the uplink multicast frame, and the DA is set as a multicast address. The uplink multicast frame is a unicast frame. Therefore, the uplink multicast frame is encrypted using a pairwise transient key (PTK) corresponding to the client device 506. Then, the encrypted uplink multicast frame is transmitted to the AP 502. The AP 502 receives the decrypted uplink multicast frame and obtains the PTK corresponding to the client device 506. Then, the AP 502 uses the obtained PTK to decrypt the encrypted uplink multicast frame. The AP 502 may further determine the ID of the sub-network that the client device 506 lies in. The AP 502 may store the ID of the sub-network and the IDs of the client devices in the sub-networks. Then, the AP obtains the unique GTK corresponding to the sub-networks 504 and encrypts the decrypted uplink multicast frame 512 using the unique GTK corresponding to the sub-networks 504. The encrypted uplink multicast frame is transmitted to the client devices in the sub-networks 504. In this case, the client device 508 and the client device 510 may receive the encrypted uplink multicast frame and decrypt the encrypted uplink multicast frame using the unique GTK corresponding to the sub-networks 504. Thus, the transmission of the multicast frame for the client devices in the sub-network is implemented.

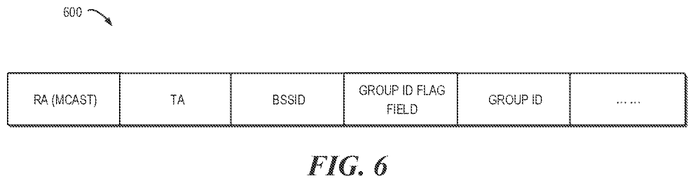

FIG. 6 illustrates an example 600 of a segmented multicast data frame according to implementations of the present disclosure. For each VLAN/PAN under the SSID, the AP manages a separate group key (GTK) with a group ID associated with it. Each VLAN/PAN is a sub-network, and the group ID is an ID of a sub-network. This group key is allocated and updated during the 802.1x authentication process. The group ID is added to the wireless multicast/unicast data frame. The client device may use the group ID to filter multicast/broadcast frames before sending it to wireless stacks. As shown in FIG. 6, a new type of frame is used. The frame may be referred to as a segmented multicast data frame. The frame format of the segmented multicast data frame is redefined, for example, by inserting a group ID field into the frame header. For the transmitter, the group ID is used to index the corresponding group encryption key, and for the receiver, it's used to check whether this frame is to him or not.

Furthermore, in the segmented multicast data frame, if the frame is a multicast frame, the RA is set as a multicast address. If the frame is not a multicast frame, the RA is set in a normal way. Moreover, the group ID flag field is added to the segmented multicast data frame, which is used to determine whether the multicast frame is transmitted to a sub-network. For example, if the frame is a multicast frame, and if the multicast frame is not transmitted to a VLAN/PAN, the group ID flag field is set to 0, which indicates that the multicast frame is processed in a normal way. In this case, the group ID field does not need to be configured. If the group ID flag field is set to 1, it indicates that the multicast frame is transmitted to a VLAN/PAN. Then, the group ID field is set as the ID of the VLAN/PAN, which receives the multicast frame.

When the AP transmits a multicast frame, it will set the RA field in the frame header as a multicast address. If the multicast frame is transmitted to a target VLAN/PAN, the group ID flag field in the frame header is set to 1 by the AP. Then, the AP set the group ID field in the frame header as the ID of the VLAN/PAN, which receives the multicast frame. Next, the AP encrypts the multicast frame with the GTK corresponding to the target VLAN/PAN to generate an encrypted multicast frame. The encrypted multicast frame is transmitted to the client device in the target VLAN/PAN.

When the client device connects to the AP and receives the encrypted multicast frame. It can determine whether the received frame is a multicast frame based on the RA field. If the RA field is not a multicast address, the client device will process the frame normally. If the RA field is a multicast address, the client device may further obtain the information in the group ID flag field. The client device further determines whether the group ID flag field is a predetermined value. If the group ID flag field is 0, it shows that the multicast is a normal multicast frame, the multicast frame will be processed by the client device in the normal way. If the group ID flag field is 1, it shows that the multicast frame is for a VLAN/PAN. Then the client device obtains its own group ID and compares its own group ID with the group ID field. If its own group ID does not match with the group ID field, it shows that the multicast frame is not to the client device. If its own group ID matches with the group ID field, it shows that the multicast frame is to the client device, and the multicast frame needs to be further processed, for example, decrypting the multicast frame with a corresponding GTK.

Furthermore, the group ID may be exchanged. After the Wi-Fi protected access (WPA) 4-way handshake, if the client is not in the default LAN group, AP will send an action frame to the client to notify the group ID. Then, the client device will confirm AP.

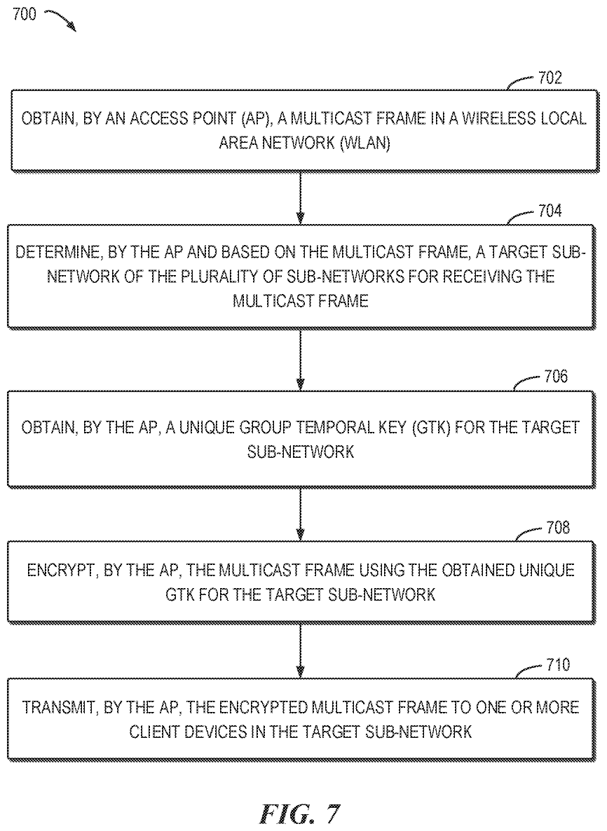

FIG. 7 illustrates a flow chart of an example method 700 for transmitting a multicast frame according to implementations of the present disclosure, and the method 700 is performed by an AP. At 702, the AP obtains a multicast frame in a wireless local area network (WLAN), the WLAN including a plurality of sub-networks with a same service set identifier (SSID). For example, the AP 102 may generate a multicast frame, and the multicast frame includes the source address. The multicast frame may be the 802.3/802.11 frame. In another example, the AP 102 may obtain an uplink multicast frame from a client device connected to the AP. When a client device connected to the AP needs to transmit a multicast frame to the sub-network, including the client device, the client device first needs to transmit an uplink multicast frame to the AP 102. The uplink multicast frame at least includes a receiver address (RA), a transmitter address (TA), and a destination address (DA). The RA may be set as a basic service set identifier (BSSID), the TA may be set as the address of the client device which transmits the uplink multicast frame, and the DA is set as a multicast address:

At 704, the AP determines, based on the multicast frame, a target sub-network of the plurality of sub-networks for receiving the multicast frame. For example, the multicast frame is generated by the AP. The multicast frame includes the source address, and the source address may be used to store the ID of the sub-network which receives the multicast frame. Then, the AP may determine the target sub-network from the plurality of sub-networks based on the address source. In another example, the AP may receive an uplink multicast frame, and the client device transmitting the uplink multicast frame may be determined from the TA field of the header of the uplink multicast frame. The TA field may be used to store the address of the terminal device, which is used as the ID of the terminal device. Then, the sub-network may be determined based on the ID of the sub-network. Furthermore, the AP stores a mapping relationship between the sub-network and the corresponding client device.

At 706, the AP obtains a unique group temporal key (GTK) for the target sub-network, the plurality of sub-networks being assigned with a plurality of different GTKs. For example, the AP 102 may store information about the sub-networks and corresponding GTKs, such as a mapping relationship between the sub-networks and corresponding GTKs. If the AP 102 determines the target sub-network, it can determine a unique GTK for the target sub-network based on the mapping relationship. The GTK is assigned to the sub-network by the AP. When a client establishes a connection with the AP 102, the AP will transmit to the client device the GTK of a sub-network that the client device belongs to.

At 708, the AP encrypts the multicast frame using the obtained unique GTK for the target sub-network. For example, after the AP 102 obtains the unique GTK for the target sub-network, the AP 102 encrypts the multicast frame using the obtained unique GTK for the target sub-network. Because that the multicast frame is encrypted with the obtained unique GTK for the target sub-network, only the client devices in the target sub-network can decrypt the encrypted multicast frame. The AP may use any suitable algorithm to encrypt the multicast frame based on the GTK. For example, the algorithm is an advanced encryption standard algorithm.

At 710, the AP transmits the encrypted multicast frame to one or more client devices in the target sub-network. As an example, after the AP 102 generates the encrypted multicast frame, the AP 102 transmits the multicast frame to the client devices in the target sub-network. The client devices connecting to the AP may receive the encrypted multicast frame. However, the multicast frame is encrypted with the unique GTK for the target sub-network. Therefore, only the client devices in the sub-network may use the unique GTK to decrypt the encrypted multicast frame. In this case, only the client devices for the target sub-network can obtain the information from the multicast, and the other client devices in other sub-networks cannot decrypt the encrypted multicast frame, because the client devices in the other sub-networks do not have the unique GTK for the target sub-network.

In this way, the AP can use a unique GTK for a target sub-network to encrypt a multicast frame to transmit to the target sub-network. Most importantly, this way can efficiently prevent other client devices in other sub-networks from decrypting the encrypted multicast frame and obtaining the information in the multicast frame, and finally avoid leaking the multicast frame to all client devices and ensure data safety.

Moreover, when the AP transmits the multicast frame, it only needs to check the PS status of the client devices in the target sub-network. For example, if the AP 102 transmits the multicast frame to the sub-network, it only needs to check the PS status of the client devices in the sub-network. During the check process, if any one of the client devices in the sub-network is in PS, the AP would not transmit the multicast frame 404 to the client devices in the sub-network. The AP needs to buffer the multicast frame 404. In one implementation, the AP will first transmit an ATIM to the client devices in the sub-network 406 to notify the client devices in the sub-network that there is pending traffic to be transmitted. Then, the AP transmits the multicast frame to the clients in the sub-network. In another implementation, the AP waits for all client devices in the sub-network to wake up. When all client devices in the sub-network wake up, the AP transmits the multicast frame to the client devices in the sub-network. Therefore, the AP has more chance to send out the multicast frame immediately, and the latency is lower than the traditional way.

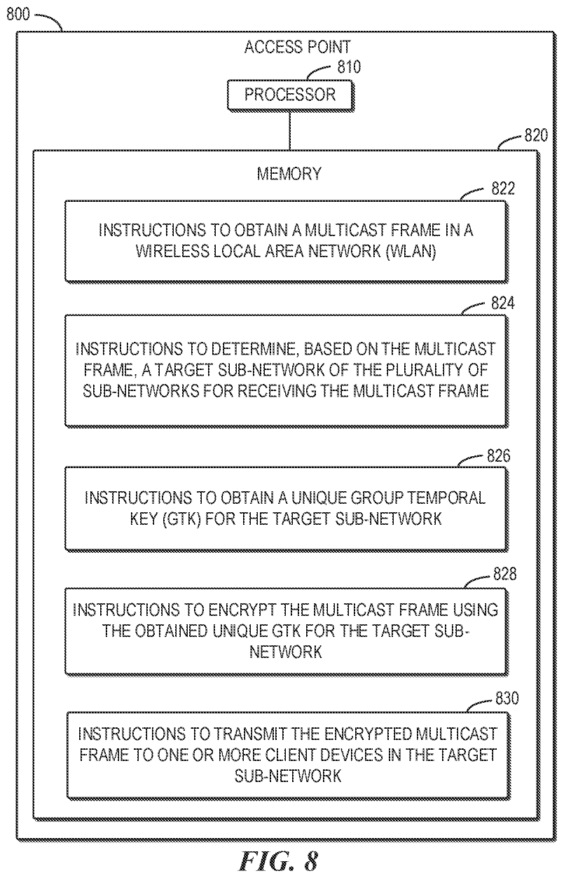

FIG. 8 illustrates an example AP 800 according to implementations of the present disclosure. As shown in FIG. 8, the terminal device 800 comprises at least one processor 810 and a memory 820 coupled to the processor 810. The memory 820 stores instructions 822, 824, 826, 828, and 830 to cause the processor 810 to perform actions according to reference implementations of the present disclosure.

As shown in FIG. 8, the memory 820 stores instructions 822 to obtain a multicast frame in a wireless local area network (WLAN), the WLAN including a plurality of sub-networks with a same service set identifier (SSID). As an example, the instruction 822 is executed by the processor 810 to obtain a multicast frame.

The memory 820 further stores instructions 824 to determine, based on the multicast frame, a target sub-network of the plurality of sub-networks for receiving the multicast frame. For example, the instruction 824 is executed by the processor 810 to determine, based on the multicast frame, a target sub-network of the plurality of sub-networks for receiving the multicast frame.

As shown in FIG. 8, the memory 820 further stores instructions 826 to obtain a unique group temporal key (GTK) for the target sub-network, the plurality of sub-networks being assigned with a plurality of different GTKs. As an example, the instruction 826 is executed by the processor 810 to obtain a unique group temporal key (GTK) for the target sub-network. The target sub-network. is one of the plurality of sub-networks based on the same SSID. The AP assigns a GTK for each of the plurality of sub-networks, and a GTK assigned to a sub-network is different from a GTK assigned to another sub-network. Therefore, the plurality of sub-networks has a plurality of different GTKs.

The memory 820 further stores instructions 828 to encrypt the multicast frame using the obtained unique GTK for the target sub-network. For example, the instruction 828 is executed by the processor 810 to encrypt the multicast frame using the obtained unique GTK for the target sub-network.

As shown in FIG. 8, the memory 820 further stores instructions 830 to transmit the encrypted multicast frame to one or more client devices in the target sub-network. As an example, the instruction 830 is executed by the processor 810 to transmit the encrypted multicast frame to one or more client devices in the target sub-network. Therefore, the AP 800 may transmit the encrypted multicast frame without leaking the encrypted multicast frame to client devices in other sub-networks.

Program codes or instructions for carrying out methods of the present disclosure may be written in any combination of one or more programming languages. These program codes or instructions may be provided to a processor or controller of a general-purpose computer, special-purpose computer, or other programmable data processing apparatus, such that the program codes, when executed by the processor or controller, cause the functions/operations specified in the flowcharts and/or block diagrams to be implemented. The program code or instructions may execute entirely on a machine, partly on the machine, as a stand-alone software package, partly on the machine and partly on a remote machine, or entirely on the remote machine or server.

Program codes or instructions for carrying out methods of the present disclosure may be written in any combination of one or more programming languages. These program codes or instructions may be provided to a processor or controller of a general-purpose computer, special-purpose computer, or other programmable data processing apparatus, such that the program codes when executed by the processor or controller, cause the functions/operations specified in the flowcharts and/or block diagrams to be implemented. The program code or instructions may execute entirely on a machine, partly on the machine, as a stand-alone software package, partly on the machine and partly on a remote machine, or entirely on the remote machine or server.

In the context of this disclosure, a machine-readable medium may be any tangible medium that may contain or store a program for use by or in connection with an instruction execution system, apparatus, or device. The machine-readable medium may be a machine-readable signal medium or a machine-readable storage medium. A machine-readable medium may include but is not limited to an electronic, magnetic, optical, electromagnetic, infrared, or semiconductor system, apparatus, device, or any suitable combination of the foregoing. More specific examples of the machine-readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order or that all illustrated operations be performed to achieve desirable results. In certain circumstances, multitasking and parallel processing may be advantageous. Certain features that are described in the context of separate implementations may also be implemented in combination in a single implementation. Conversely, various features that are described in the context of a single implementation may also be implemented in multiple implementations separately or in any suitable sub-combination.

In the foregoing Detailed Description of the present disclosure, reference is made to the accompanying drawings that from a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

What is claimed:

1. A method comprising:
obtaining, by an access point (AP), a multicast frame in a wireless local area network (WLAN), the WLAN including a plurality of sub-networks with a same service set identifier (SSID);
determining, by the AP and based on the multicast frame, a target sub-network of the plurality of sub-networks for receiving the multicast frame;
obtaining, by the AP, a unique group temporal key (GTK) for the target sub-network, the plurality of sub-networks being assigned with a plurality of different GTKs;
encrypting, by the AP, the multicast frame using the obtained unique GTK for the target sub-network; and
transmitting, by the AP, the encrypted multicast frame to one or more client devices in the target sub-network.

2. The method according to claim 1, wherein obtaining the multicast frame in the WLAN comprises:
generating a predetermined type of frame, a frame header of the predetermined type of frame including a receiver address field, a group identifier flag field for a sub-network and a group identifier field for the sub-network;
determining the receiver address field based on a multicast address;
determining the group identifier flag field based on a predetermined value to indicate that an identifier of the target sub-network is used in the predetermined type of frame; and
determining the group identifier field based on the identifier of the target sub-network.

3. The method according to claim 2, further comprising:
transmitting the identifier for the target sub-network to the one or more client devices in the target sub-network.

4. The method according to claim 1, wherein determining the target sub-network of the plurality of sub-networks for receiving the multicast frame comprises:
determining a source address in a frame header of the multicast frame; and
determining the target sub-network based on the source address.

5. The method according to claim 1, wherein obtaining the GTK for the target sub-network comprises:
obtaining a mapping relationship between the plurality of different GTKs and the plurality of sub-networks; and
determining the unique GTK for the target sub-network based on the mapping relationship.

6. The method according to claim 1, wherein transmitting the encrypted multicast frame to the one or more client devices in the target sub-network comprises:
checking power save (PS) status of all client devices in the target sub-network;
determining that all client devices in the target sub-network are not in PS status; and
transmitting the encrypted multicast frame to one or more client devices in the target sub-network.

7. The method according to claim 1, further comprising:
receiving a connecting request from a target client device, the connecting request including a credential; and
determining the target sub-network including the target client device based on the credential.

8. The method according to claim 7, wherein credentials from all the client devices in the target network are the same.

9. The method according to claim 1, further comprising:
assigning the unique GTK to the one or more client devices during authentication processes for the one or more client devices.

10. An access point (AP) comprising:
at least one processor;
a memory coupled to the at least one processor, the memory storing instructions to cause the at least one processor to:
obtain a multicast frame in a wireless local area network (WLAN), the WLAN including a plurality of sub-networks with a same service set identifier (SSID);
determine, based on the multicast frame, a target sub-network of the plurality of sub-networks for receiving the multicast frame;
obtain a unique group temporal key (GTK) for the target sub-network, the plurality of sub-networks being assigned with a plurality of different GTKs;
encrypt the multicast frame using the obtained unique GTK for the target sub-network; and
transmit the encrypted multicast frame to one or more client devices in the target sub-network.

11. The access point according to claim 10, wherein the instructions to obtain the multicast frame in the WLAN comprises instructions to cause the at least one processor to:
generating a predetermined type of frame, a frame header of the predetermined type of frame including a receiver address field, a group identifier flag field for a sub-network and a group identifier field for the sub-network;
determining the receiver address field based on a multicast address;
determining the group identifier flag field based on a predetermined value to indicate that an identifier of the target sub-network is used in the predetermined type of frame; and
determining the group identifier field based on the identifier of the target sub-network.

12. The access point according to claim 11, further comprising instructions to cause the at least one processor to:
transmitting the identifier for the target sub-network to the one or more client devices in the target sub-network.

13. The access point according to claim 10, wherein the instructions to determine the target sub-network of the plurality of sub-networks for receiving the multicast frame comprises instructions to cause the at least one processor to:
determining a source address in a frame header of the multicast frame; and
determining the target sub-network based on the source address.

14. The access point according to claim 10, wherein the instructions to obtain the GTK for the target sub-network comprises instructions to cause the at least one processor to:
obtaining a mapping relationship between the plurality of different GTKs and the plurality of sub-networks; and
determining the unique GTK for the target sub-network based on the mapping relationship.

15. The access point according to claim 10, wherein the instructions to transmit the encrypted multicast frame to the one or more client devices in the target sub-network comprises instructions to cause the at least one processor to:
checking power save (PS) status of all client devices in the target sub-network;
determining that all client devices in the target sub-network are not in PS status; and
transmitting the encrypted multicast frame to one or more client devices in the target sub-network.

16. The access point according to claim 10, further comprising instructions to cause the at least one processor to:
receiving a connecting request from a target client device, the connecting request including a credential; and
determining the target sub-network including the target client device based on the credential.

17. The access point according to claim 16, wherein credentials from all the client devices in the target network are the same.

18. The access point according to claim 16, further comprising instructions to cause the at least one processor to:
assign the unique GTK to the one or more client devices during authentication processes for the one or more client devices.

19. A non-transitory computer-readable medium comprising instructions stored thereon which, when executed by an access point (AP), cause the AP to:
obtain a multicast frame in a wireless local area network (WLAN), the WLAN including a plurality of sub-networks with a same service set identifier (SSID);
determine, based on the multicast frame, a target sub-network of the plurality of sub-networks for receiving the multicast frame;
obtain a unique group temporal key (GTK) for the target sub-network, the plurality of sub-networks being assigned with a plurality of different GTKs;
encrypt the multicast frame using the obtained unique GTK for the target sub-network; and
transmit the encrypted multicast frame to one or more client devices in the target sub-network.

20. The non-transitory computer-readable medium according to claim 19, wherein obtain the multicast frame in the WLAN comprises:
generating a predetermined type of frame, a frame header of the predetermined type of frame including a receiver address field, a group identifier flag field for a sub-network and a group identifier field for the sub-network;
determining the receiver address field based on a multicast address;
determining the group identifier flag field based on a predetermined value to indicate that an identifier of the target sub-network is used in the predetermined type of frame; and
determining the group identifier field based on the identifier of the target sub-network.
